(19) United States
(12) Patent Application Publication
(10) Pub. No.: US 2009/0310244 A1
(43) Pub. Date: Dec. 17, 2009

(54) THIN-FILM MAGNETIC HEAD FOR MICROWAVE ASSIST AND MICROWAVE-ASSISTED MAGNETIC RECORDING METHOD

(75) Inventors: Koji Shimazawa, Tokyo (JP); Tsutomu Chou, Tokyo (JP); Yoshihiro Tsuchiya, Tokyo (JP)

Correspondence Address: FROMMER LAWRENCE & HAUG, 745 FIFTH AVENUE- 10TH FL., NEW YORK, NY, 10151, US

(73) Assignee: TDK Corporation, Tokyo (JP)

(21) Appl. No.: 12/140,670

(22) Filed: Jun. 17, 2008

(51) Int. Cl. G11B 21/02; G11B 5/127; G11B 5/48

(52) U.S. Cl. 360/75; 360/110; 360/245.3; G9B/5.04; G9B/5.147; G9B/21.003

(57) ABSTRACT

Provided is a thin-film magnetic head that can stably generate electromagnetic field with a desired frequency, even under the existence of significantly strong write field with frequently reversed direction. The head comprises an electromagnetic-field generating element between the first and second magnetic poles. The electromagnetic-field generating element comprises a spin-wave excitation layer provided adjacent to the first magnetic pole and having a magnetization with its direction varied according to external magnetic fields, for generating an high frequency electromagnetic field by an excitation of spin wave. And a magnetization of the spin-wave excitation layer is biased in a direction substantially perpendicular to its layer surface by a portion of magnetic field generated from the first magnetic pole, and pin-wave excitation current flows in the electromagnetic-field generating element in a direction from the second pole to the first pole.

### BACKGROUND OF THE INVENTION

1. Field of the Invention

The present invention relates to a thin-film magnetic head using for microwave-assisted magnetic recording technique in which data are written to a portion of magnetic recording medium irradiated with microwave, and relates to a magnetic recording method by the technique.

2. Description of the Related Art

In magnetic recording apparatuses, especially magnetic disk drive apparatuses, intended for higher recording density, thin-film magnetic heads within them need to be further improved in its performance. As such thin-film magnetic heads, composite-type thin-film magnetic heads are widely used, which have a stacked structure of a magnetoresistive (MR) element for reading data and an electromagnetic transducer for writing data. These elements perform read and write operations to magnetic disks as magnetic recording media.

Generally, a magnetic recording medium is magnetically discontinuous, in which magnetic microparticles are gathered together. Usually, each of the magnetic microparticles has a single magnetic-domain structure; and in the medium, one record bit consists of a plurality of the magnetic microparticles. Therefore, for improving its recording density, irregularity in the boundary of the record bit is required to be reduced by decreasing the size (volume) of the magnetic microparticle. However, a problem is likely to occur that the decrease in size causes thermal stability of the magnetization of the record bit to be degraded.

A guide of the thermal stability of the magnetization is given as K_{U}V/k_{B}T, where K_{U} is a magnetic anisotropy energy in the microparticle, V is a volume of a single microparticle, k_{B} is Boltzmann constant and T is absolute temperature. Decreasing the size of the microparticle is equivalent to decreasing the volume V. Therefore, when the size is decreased, the thermal stability is degraded due to the degrease in K_{U}V/K_{B}T value. As a measure against the thermal stability problem, it may be possible to increase the magnetic anisotropy energy K_{U}. However, the increase in energy K_{U} causes the increase in coercive force of the magnetic recording medium. Whereas, write field intensity of the thin-film magnetic head is limited by the amount of saturation magnetic flux density of the soft-magnetic pole material of which the magnetic core of the head is formed. Therefore, the head cannot write data to the magnetic recording medium when the coercive force of the medium exceeds the write field limit.

As the first method for solving the thermal stability problem, patterned media may be considered as a candidate. While one recording bit consists of N pieces of the magnetic microparticles in the conventional magnetic recording as described above, one recording bit is a single pattern region with volume NV in the patterned media. As a result, the value of the guide of the thermal stability becomes K_{U}NV/K_{B}T, which means significant improvement of the thermal stability.

As the second method for solving the thermal stability problem, so-called heat-assisted magnetic recording technique is proposed, in which a magnetic head writes data to a magnetic recording medium formed of a material with large magnetic anisotropy energy K_{U} by reducing the coercive force of the medium with heat supplied to the medium just before the write field is applied. The heat-assisted magnetic recording technique has some similarity to a magneto-optic recording technique. However in the heat-assisted magnetic recording technique, the area of applied magnetic field determines spatial resolution of record bits, whereas in the magneto-optic recording technique, the area of emitted light determines spatial resolution of record bits.

However, the above-described first and second methods requires a significant change to the conventional structure of media or heads, and are vary difficult to realize due to technical and cost barriers. Currently, as the third method against the difficulties, Zhu et al. in Carnegie Mellon University proposes a microwave-assisted magnetic recording technique described, for example, in IEEE TRANSACTIONS ON MAGNETICS Vol. 44, No. 1, pp 125-131, January 2008. This technique utilizes a structure in which an MR element is inserted between a main pole and a trailing shield of the conventional write head element. The structure is easy to form, compared to those for the above-described first and second methods. In addition, WO 2003/010758 and Japanese Patent Publication No. 2005-285242A disclose microwave-assisted magnetic recording techniques of the same kind.

In the proposed microwave-assisted magnetic recording techniques, used is a spin-wave excitation element including: a magnetization free layer that is formed adjacent to the write pole and has a magnetization with its direction varied according to external magnetic fields; a non-magnetic layer stacked on the magnetization free layer; a magnetization pinned layer that is stacked on the non-magnetic layer and has a magnetization with fixed direction; and a pair of electrodes for applying electric current to this stacked structure. In the spin-wave excitation element, electric current is applied in the direction perpendicular to each of the layer surfaces. The electric current transports spins of electrons, which causes a spin torque. The spin torque causes the magnetization of the free layer to start a precession movement. Then, spin wave is excited by the precession movement. From the magnetization free layer with the spin wave excited, electro-magnetic field having a high frequency within microwave range leaks out. Then, the magnetization of the portion of the magnetic recording layer of the magnetic recording medium receiving the electro-magnetic field is given a fluctuation. As a result, a reverse of the magnetization direction of the magnetic recording layer can be realized, which would have been impossible by only write field generated from the main magnetic pole.

In this occasion, the frequency of the high frequency electromagnetic field, that is, a frequency of the precession movement of the magnetization of the free layer needs to be tuned to an inherent frequency for magnetic resonance of the magnetic recording layer. Therefore, adjusted are the thickness of the magnetization free layer, bias magnetic field applied in advance to the free layer, and the amount of electric current for exciting the spin wave. The above referred IEEE TRANSACTIONS ON MAGNETICS Vol. 44, No. 1, pp 125-131, January 2008 discloses that a layer with perpendicular anisotropy is provided so as to contact with the magnetization free layer, and the frequency of precession movement is controlled by adjusting the degree of the perpendicular anisotropy of the layer.

However, there are at least two problems in the above-described conventional techniques. The first problem is to realize the stability of the magnetization in the pinned layer. The magnetization of the pinned layer in the spin-wave excitation element is fixed in one direction; it is required to maintain the fixed direction stably, even under the existence of external magnetic fields or electric current applied for exciting spin wave. Otherwise, the amount of the generated spin torque would become varying; thus the desired stable precession movement of the magnetization of the free layer could not be realized. Here, the spin-wave excitation element is positioned adjacent to the main magnetic pole, and thus suffers write field with extremely high intensity. The received magnetic field reaches, for example, approximately 10 kOe (kilo-Oersted) or more. Further, the direction of the write field is frequently reversed according to data to be written. However, it is very difficult to find out a material for the pinned layer having a large coercive force, which stands against such significantly strong magnetic field whose direction is frequently reversed.

Further, the second problem is to adjust the frequency of precession movement of the magnetization in the magnetization free layer. In the above-described conventional technique, the frequency of precession movement is set to be a predetermined value by controlling the thickness of the magnetization free layer, the degree of perpendicular anisotropy in the layer with perpendicular anisotropy, and so on. However, any influence to the frequency brought by the write field, which the spin wave excitation element receives from the main magnetic pole, is not taken into consideration at all. Therefore, the frequency of precession movement may vary in a large extent from the predetermined value due to the write field; in some case, there would occur no precession movement.

### SUMMARY OF THE INVENTION

Therefore, an object of the present invention is to provide a thin-film magnetic head that can stably generate electromagnetic field with a desired high frequency, even under the existence of significantly strong write field whose direction is frequently reversed.

Another object of the present invention is to provide a magnetic recording method in which electromagnetic field with a desired high frequency can stably be applied to the magnetic recording medium, even during applying significantly strong write field whose direction is frequently reversed.

Before describing the present invention, terms used herein will be defined. In the structure of a multilayer or an element formed on/above the element formation surface of a slider substrate of the thin-film magnetic head, the side of the slider substrate, when viewed from a standard layer or element, is referred to as being “lower” side with respect to the standard layer or element; and the side opposite to the substrate is referred to as being “upper” side with respect to the standard layer or element. Further, a portion on the substrate side of a layer or element is referred to as being “lower” portion; and a portion on the side opposite to the substrate is referred to as being “upper” portion.

Further, in some figures showing embodiments of the magnetic head according to the present invention, “X-axis direction”, “Y-axis direction” and “Z-axis direction” are defined according to need. Here, X-axis direction is equivalent to the above-described “upper-to-lower direction”, and +X direction corresponds to the trailing side, and −X direction corresponds to the leading side. Further, Y-axis direction corresponds to the track width direction, and Z-axis direction corresponds to the height direction.

According to the present invention, a thin-film magnetic head is provided, which comprises:

a first magnetic pole (a main pole magnetic layer 340 in the embodiment shown in FIG. 2) for generating a write field for writing to a magnetic recording medium, and a second magnetic pole (a write shield layer 345 in the embodiment shown in FIG. 2); and an electromagnetic-field generating element provided in a position reaching an opposed-to-medium surface, between the first magnetic pole and the second magnetic pole, and in the thin-film magnetic head,

the electromagnetic-field generating element comprises; a spin-wave excitation layer provided adjacent to the first magnetic pole and having a magnetization with its direction varied according to external magnetic fields, for generating an high frequency electromagnetic field by an excitation of spin wave; and a non-magnetic intermediate layer provided on a side opposite to the first magnetic pole in relation to the spin-wave excitation layer, and

a magnetization of the spin-wave excitation layer is biased in a direction substantially perpendicular to its layer surface by a portion of magnetic field generated from the first magnetic pole, and an electric current for exciting the spin wave flows in the electromagnetic-field generating element in a direction from the second magnetic pole to the first magnetic pole.

In the electromagnetic-field generating element of the thin-film magnetic head according to the present invention, the magnetization of the spin-wave excitation layer is biased by a portion of magnetic field generated from the first magnetic pole. The portion of magnetic field is very strong and is frequently reversed. However, by applying electric current for exciting spin wave in the direction from the second magnetic pole to the first magnetic pole, high frequency electromagnetic field with a desired frequency f_{M} in microwave range can be stably generated from the spin-wave excitation layer.

Here, “a direction substantially perpendicular to its layer surface” means as follows: The magnetic flux corresponding to magnetic field generated from the first magnetic pole provided for generating write field, has a contour of curved line, not a straight line in a precise sense, even in the electromagnetic-field generating element. And the degree of the curve depends on the design of the head. Therefore, even in the case that: the electromagnetic-field generating element is provided between the first magnetic pole and the second magnetic pole; and the magnetic flux curves slightly due to a certain head design; thus the corresponding magnetic field slightly deviates from the direction perpendicular to the layer surface, the magnetic field is regarded to be “substantially” perpendicular to the layer surface.

In the thin-film magnetic head according to the present invention, the spin-wave excitation layer preferably has a magnetic anisotropy energy of 1×10⁴ erg/cm³ or less, and also preferably has an axis of easy magnetization perpendicular to its layer surface. And it is also preferable that: the spin-wave excitation layer further comprises a magnetization free layer having a magnetization with its direction varied according to external magnetic fields; the non-magnetic intermediate layer is provided in a position sandwiched between the magnetization free layer and the spin-wave excitation layer; and a magnetization of the magnetization free layer is biased in a direction substantially perpendicular to its layer surface by a portion of magnetic field generated from said first magnetic pole. In this case of comprising the magnetization free layer, the magnetization free layer preferably has a magnetic anisotropy energy of 1×10⁴ erg/cm³ or less, and also preferably has an axis of easy magnetization perpendicular to its layer surface.

Further, in the thin-film magnetic head according to the present invention, it is preferable that the second magnetic pole comprises a protruding portion that is provided on an end portion on the opposed-to-medium surface side of the second magnetic pole, opposed to the first magnetic pole, and protrudes toward the first magnetic pole, and the electromagnetic-field generating element is provided between the protruding portion and the first magnetic pole. Further it is also preferable that the first magnetic pole comprises a protruding portion that is provided on an end portion on the opposed-to-medium surface side of the first magnetic pole, opposed to the second magnetic pole, and protrudes toward the second magnetic pole, and the electromagnetic-field generating element is provided between the protruding portion and the second magnetic pole. Due to the existence of the protruding portion(s), the direction of the portion of magnetic field generated from the first magnetic pole surely becomes perpendicular to each of layer surfaces of the electromagnetic-field generating element. Thereby realized is more adequate biased state, and thus more stable high frequency electromagnetic field can be generated.

Further, in the thin-film magnetic head according to the present invention, it is preferable that a portion of the first magnetic pole or the second magnetic pole is formed of an electrically insulating layer, and an end portion on the opposed-to-medium surface side of the first magnetic pole and an end portion on the opposed-to-medium surface side of the second magnetic pole act as electrodes for applying the electric current for exciting the spin wave to the electromagnetic-field generating element. And it is also preferable that a width in a track width direction of an end on the opposed-to-medium surface side of the electromagnetic-field generating element is smaller than a width in a track width direction of an end on the opposed-to-medium surface side of the first magnetic pole. Further, a frequency of the high frequency electromagnetic field generated from said spin-wave excitation layer is preferably substantially equal to a magnetic resonance frequency of a magnetic recording layer of the magnetic recording medium to be written. Here, “substantially equal to a magnetic resonance frequency” means as follows: Even in the case that the frequency f_{M} of high frequency electromagnetic field, with which the magnetic recording medium is irradiated, is shifted slightly from the magnetic resonance frequency f_{R} of the perpendicular magnetization layer of the magnetic recording medium, the anisotropic magnetic field of the perpendicular magnetization layer can be reduced accordingly. Therefore, the range of the frequency f_{M} in which the anisotropic magnetic field of the perpendicular magnetization layer is reduced to the degree of enabling write operation, can be regarded as a range of “being substantially equal to the magnetic resonance frequency”.

According to the present invention, a head gimbal assembly (HGA) is further provided, which comprises: the above-described thin-film magnetic head; and a support structure for supporting the thin-film magnetic head.

Further, according to the present invention, a magnetic recording apparatus is provided, which comprises: at least one HGA described above; at least one magnetic recording medium; and a recording circuit for controlling write operation of the thin-film magnetic head performed to the at least one magnetic recording medium, the recording circuit further comprising a spin-wave control circuit for controlling the electric current for exciting the spin wave.

Furthermore, according to the present invention, a magnetic recording method is provided, which comprises steps of:

biasing a magnetization of a spin-wave excitation layer including a layer surface perpendicular to an opposed-to-medium surface and having the magnetization with its direction varied according to external magnetic fields, in a direction substantially perpendicular to the layer surface, by a portion of magnetic field generated from a magnetic pole;

exciting a spin wave in the spin-wave excitation layer by applying an electric current to the spin-wave excitation layer with its magnetization biased;

reducing an anisotropic magnetic field of a portion of a magnetic recording medium, by applying a high frequency magnetic field generated by the spin wave to the portion of the magnetic recording medium, the high frequency magnetic field including an in-plane component in a direction within the magnetic recording medium; and

performing writing on the portion with the reduced anisotropic magnetic field of the magnetic recording medium, by applying a write field generated from the magnetic pole.

By using the magnetic recording method according to the present invention, high frequency electromagnetic field with a desired frequency can be applied stably to the magnetic recording medium, even during applying significantly strong write field whose direction is frequently reversed. Thereby, an excellent microwave-assisted magnetic recording can be realized.

In the magnetic recording method according to the present invention, a magnetic anisotropy energy of the spin-wave excitation layer is preferably set to be 1×10⁴ erg/cm³ or less, and an axis of easy magnetization of the spin-wave excitation layer is preferably set to be perpendicular to its layer surface. Further, it is preferable that, in a multilayer of the spin-wave excitation layer, a non-magnetic intermediate layer and a magnetization free layer having a magnetization with its direction varied according to external magnetic fields, magnetizations of the spin-wave excitation layer and the magnetization free layer are biased in a direction substantially perpendicular to their layer surfaces by a portion of magnetic field generated from the magnetic pole, and an electric current is applied to the multilayer from the magnetization free layer side to the spin-wave excitation layer side. Furthermore, a frequency of the high frequency electromagnetic field generated from the spin-wave excitation layer is preferably set to be substantially equal to a magnetic resonance frequency of a magnetic recording layer of the magnetic recording medium to be written.

Further, the electric current is preferably applied to the spin-wave excitation layer after the write field rises from the magnetic pole, and the electric current is stopped before the write field falls. In this case, the electric current for the spin-wave excitation is supplied necessarily under the condition of stably applying a portion of magnetic field generated from the first magnetic pole as a bias magnetic field. Therefore, stable high frequency electromagnetic field with an intended frequency can be generated.

Further objects and advantages of the present invention will be apparent from the following description of preferred embodiments of the invention as illustrated in the accompanying figures. In each figure, the same element as an element shown in other figure is indicated by the same reference numeral. Further, the ratio of dimensions within an element and between elements becomes arbitrary for viewability.

### BRIEF DESCRIPTION OF THE DRAWINGS

FIG. 1 shows perspective views schematically illustrating configurations of one embodiments of a magnetic recording and reproducing apparatus, an HGA and a thin-film magnetic head according to the present invention;

FIG. 2 shows a cross-sectional view taken by plane A in FIG. 1, schematically illustrating a main portion of the thin-film magnetic head;

FIG. 3a shows a top view, obtained when viewed down from the position directly above the element formation surface, schematically illustrating positions and shapes of the main magnetic pole layer, the electromagnetic-field generating element and the write shield layer of the electromagnetic transducer;

FIG. 3b shows a side view, obtained when viewed from the ABS side, schematically illustrating positions and shapes of the end surfaces of the main magnetic pole layer, the electromagnetic-field generating element and the write shield layer, which appear on the head end surface;

FIG. 4 shows a cross-sectional view taken by plane A in FIG. 1, schematically illustrating the structure of an embodiment of the electromagnetic-field generating element;

FIGS. 5a to 5c show schematic views illustrating the configuration of the electromagnetic-field generating element and its surrounding, for explaining the operating principle of the element.

FIGS. 6a to 6c show schematic views illustrating the configuration of the electromagnetic-field generating element and its surrounding, for explaining the operating principle of the element.

FIGS. 7a to 7c show cross-sectional views taken by a plane corresponding to plane A shown in FIG. 1, schematically illustrating the structures of other embodiments of the electromagnetic transducer including the electromagnetic-field generating element;

FIG. 8 shows a block diagram illustrating the circuit structure of the recording/reproducing and spin-wave control circuit of the magnetic disk drive apparatus shown in FIG. 1; and

FIG. 9 shows a graph illustrating waveforms of spin-wave excitation current, for explaining an embodiment of the magnetic recording method according to the present invention.

### DESCRIPTION OF THE PREFERRED EMBODIMENTS

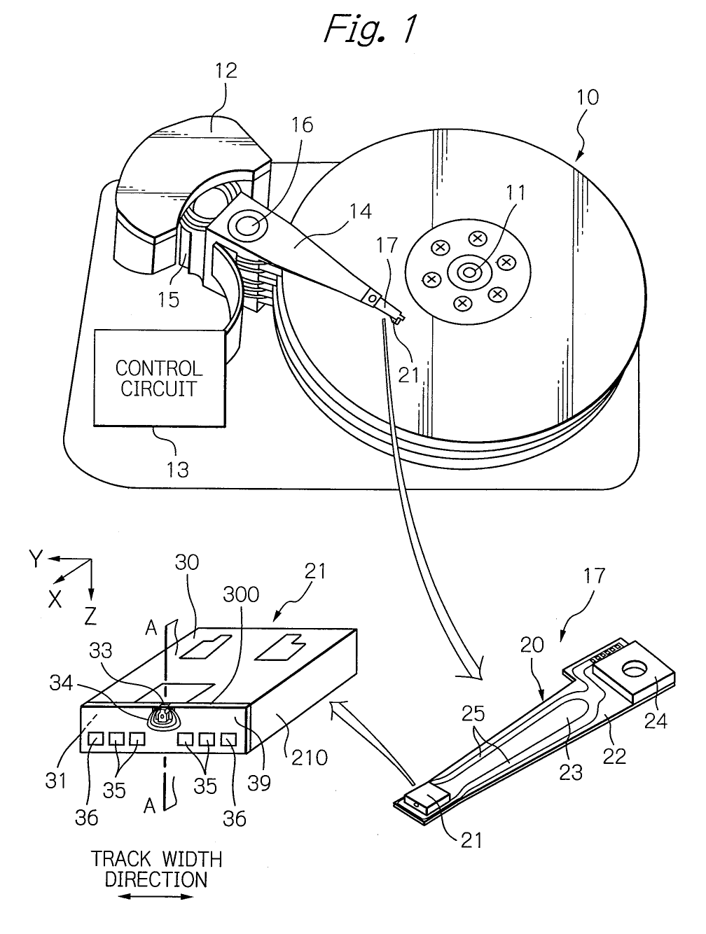

FIG. 1 shows perspective views schematically illustrating configurations of one embodiments of a magnetic recording and reproducing apparatus, an HGA and a thin-film magnetic head according to the present invention. In magnified views of the HGA and the thin-film magnetic head of FIG. 1, the side opposed to a magnetic recording medium is viewable in the figure.

The magnetic recording and reproducing apparatus shown in FIG. 1 is a magnetic disk drive apparatus, which includes: multiple magnetic disks 10 as magnetic recording media which rotate about a spindle of a spindle motor 11; an assembly carriage device 12 provided with multiple drive arms 14; head gimbal assemblies (HGAs) 17 each of which is attached on the end portion of each drive arm 14 and is provided with a thin-film magnetic head (slider) 21; and a recording/reproducing and spin-wave control circuit 13 for controlling read/write operations and controlling electric current for exciting spin wave in an electromagnetic-field generating element as described in detail later.

The magnetic disk 10 is designed for perpendicular magnetic recording, and has a stacked structure formed on/above a disk substrate, including a soft-magnetic under layer for acting as a part of magnetic circuit and a perpendicular magnetization layer as a magnetic recording layer. The assembly carriage device 12 is provided for positioning the thin-film magnetic head 21 above a track formed on the perpendicular magnetization layer of the magnetic disk 10. In the device 12, the drive arms 14 are stacked along a pivot bearing axis 16 and are capable of angular-pivoting about the axis 16 driven by a voice coil motor (VCM) 15. Here, for example, two HGAs 17 and two drive arms 14 may be provided so as to pinch a single magnetic disk 10. Further, between two magnetic disks 10, one drive arm 14 may be provided so as to support two HGAs 17 disposed for respective magnetic disks 10. Furthermore, the numbers of magnetic disks 10, drive arms 14, HGAs 17 and sliders 21 may be a single. The recording/reproducing and spin-wave control circuit 13 will be explained in detail with a figure later.

Also as shown in FIG. 1, in the HGA 17, the thin-film magnetic head 21 is fixed and supported on the end portion of a suspension 20 in such a way to face the surface of each magnetic disk 10 with a predetermined spacing (flying height). And one end of a wiring member 25 is electrically connected to terminal electrodes of the thin-film magnetic head 21.

The suspension 20 is a support structure of the thin-film magnetic head 21, which includes: a load beam 22; a flexure 23 with elasticity fixed on the load beam 22, on which the thin-film magnetic head 21 is fixed to increase its degree of freedom; and a base plate 24 provided on the base portion of the load beam 22. Further, on the flexure 23, provided is a wiring member 25 that consists of lead conductors as signal lines and connection pads electrically joined to both ends of the lead conductors. The structure of suspension 20 is not limited to the above-described one. While not shown in the figure, a head drive IC chip may be attached at some midpoints of the suspension 20.

Also as shown in FIG. 1, the thin-film magnetic head 21 includes: a slider substrate 210 having an air bearing surface (ABS) 30 processed so as to provide an appropriate flying height and an element formation surface 31, and formed of a ceramic material such as AlTiC (Al₂O₃—TiC); an magnetoresistive (MR) element 33 as a read head element for reading data and an electromagnetic transducer 34 as a write head element for writing data, which are formed on/above the element formation surface 31; an overcoat layer 39 formed so as to cover the MR element 33 and the electromagnetic transducer 34; four signal electrodes 35 exposed in the upper surface of the overcoat layer 39; and two drive electrodes 36 exposed also in the upper surface of the overcoat layer 39. Here, the ABS 30 and the head end surface 300 of the overcoat layer 39 on the ABS 30 side are opposed-to-medium surfaces, which is opposed to the magnetic disk 10. Respective two of the four signal electrodes 35 are connected to the MR element 33 and the electromagnetic transducer 34, and the two drive electrodes 36 are connected through magnetic pole layers to an electromagnetic-field generating element, as described later.

One ends of the MR element 33 and the electromagnetic transducer 34 reach the head end surface 300 on the ABS 30 side. These ends face the surface of the magnetic disk 10, and then, read operation is performed by sensing signal magnetic field from the disk 10, and write operation is performed by applying write magnetic field to the disk 10. A predetermined area of the head end surface 300 that these ends reach may be coated with diamond like carbon (DLC), etc. as an extremely thin protective film. Therefore, the meaning that one end of an element “reaches” the head end surface 300 implies the case that the outer surface of the protective film becomes the end surface 300 in a precise sense, and thus, the one end of the element is not exposed from the outer surface.

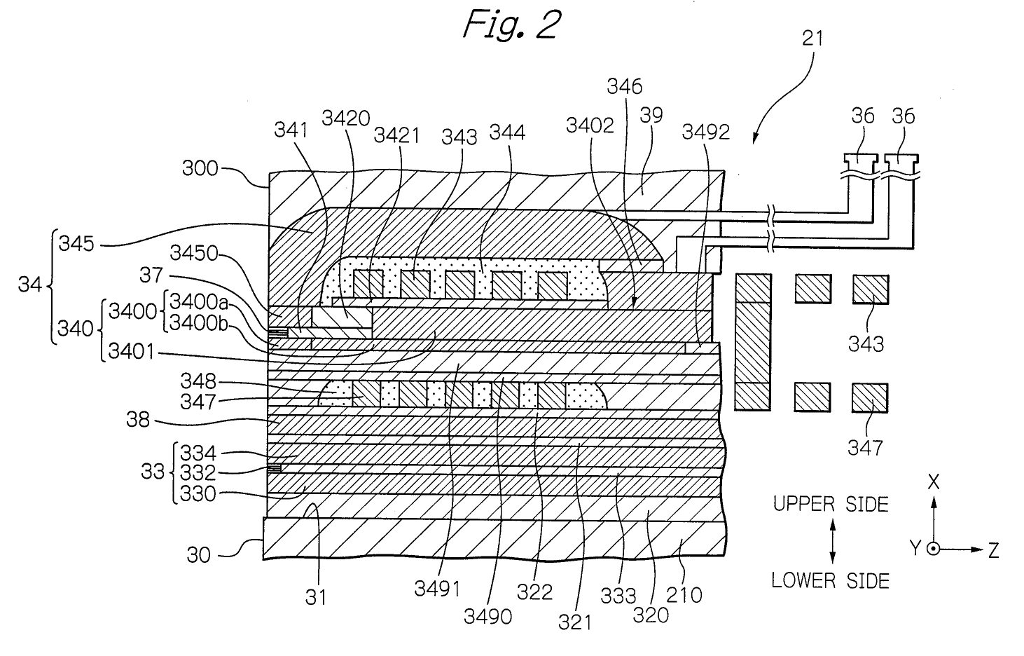

FIG. 2 shows a cross-sectional view taken by plane A in FIG. 1, schematically illustrating a main portion of the thin-film magnetic head 21. The plane A is parallel to ZX-plane.

In FIG. 2, the MR element 33 is a tunnel magnetoresistive (TMR) element, a current-perpendicular-to-plane giant magnetoresistive (CPP-GMR) element, or a current-in-plane giant magnetoresistive (CIP-GMR) element, and is formed above the element formation surface 31 of the slider substrate 210 through an insulating layer 320 made of an insulating material such as Al₂O₃ (alumina). The MR element 33 includes: an MR multilayer 332; a shield gap layer 333 formed of an insulating material such as Al₂O₃ (alumina) and covering at least the rear side surface (+Z side surface) of the MR multilayer 332; and a lower shield layer 330 and an upper shield layer 334 which sandwich the MR multilayer 332 and the shield gap layer 333 therebetween. The MR multilayer 332 is a magneto-sensitive portion part sensing signal magnetic field from the magnetic disk with very high sensitivity and making an output in the form of the change in electrical resistance (the change in voltage).

The upper and lower shield layers 334 and 330 are formed of, for example, soft-magnetic conductive material containing such as NiFe (Permalloy), CoFeNi, CoFe, FeN or FeZrN with a thickness of approximately 0.3 to 5 μm (micrometers), and act as electrodes to apply sense current in the direction perpendicular to the stacked surface of the MR multilayer 332, as well as play a role of shielding external magnetic fields that cause a noise for the MR multilayer 332.

The MR multilayer 332 includes: an antiferromagnetic layer formed of antiferromagnetic material; a pinned layer formed mainly of ferromagnetic material; a non-magnetic intermediate layer formed of an oxide (in the case of TMR element) or of non-magnetic metal (in the case of CPP-GMR or CIP-GMR element); and a free layer formed of ferromagnetic material. In the case of using the TMR element, the magnetizations of the pinned layer and the free layer make a ferromagnetic tunnel coupling with the non-magnetic intermediate layer as a barrier of tunnel effect. Thus, when the magnetization direction of the free layer changes in response to signal magnetic field, tunnel current increases/decreases due to the variation in the state densities of up and down spin bands of conduction electrons in the pinned layer and the free layer, which changes the electric resistance of the MR multilayer 332. The measurement of this resistance change enables a weak and local signal field to be detected with high sensitivity.

In the case that the MR element 33 is a CIP-GMR element, shield gap layers formed of insulating material are provided between the MR multilayer 332 and respective upper and lower shield layers 334 and 330, and further, element lead conductor layers formed of conductive material are provided for supplying the MR multilayer 332 with sense current. In this case, the upper and lower shield layers 334 and 330 do not act as electrodes.

Also as shown in FIG. 2, the electromagnetic transducer 34 is designed for perpendicular magnetic recording, and includes: a main magnetic pole layer 340; an electromagnetic-field generating element 37; a gap layer 341; a write coil layer 343; a write shield layer 345; and a backing coil layer 347.

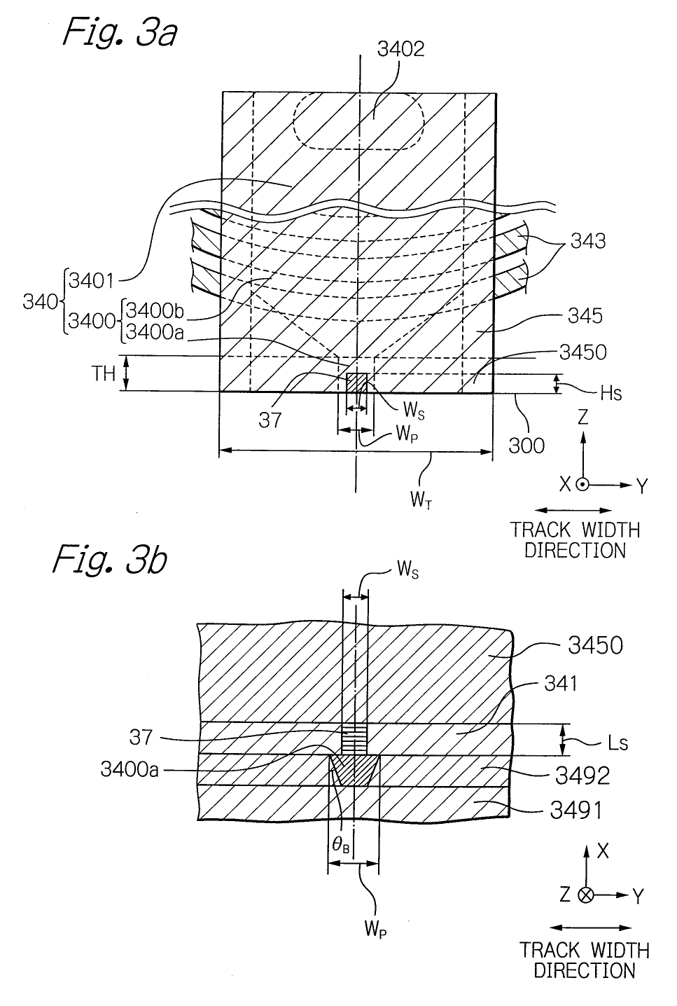

The main magnetic pole layer 340 is provided on an insulating layer 3491 formed of insulating material such as Al₂O₃ (alumina), and is a magnetic path for converging and guiding magnetic flux excited by write current flowing through the write coil layer 343, toward the magnetic recording layer (perpendicular magnetization layer) of the magnetic disk 10. The main magnetic pole layer 340 has a double-layered structure in which a main magnetic pole 3400 and a main pole body 3401 are stacked sequentially and magnetically coupled with each other. The main magnetic pole 3400 is isolated by being surrounded with an insulating layer 3492 formed of insulating material such as Al₂O₃. The main magnetic pole 3400 reaches the head end surface 300, and has: a main pole front end 3400a with a very small width W_{P} (FIG. 3b) in the track width direction (Y-axis direction); and a main pole rear end 3400b located at the rear of the main pole front end 3400a and having a width in the track width direction (Y-axis direction) larger than the width W_{P} of the main pole front end 3400a. Thus, the very small width W_{P} enables fine write field to be generated.

The main magnetic pole 3400 is formed of soft-magnetic material with saturation magnetic flux density higher than that of the main pole body 3401, which is, for example, an iron alloy with Fe as a main component, such as FeNi, FeCo, FeCoNi, FeN or FeZrN. The thickness of the main magnetic pole 3400 is, for example, in the range of approximately 0.2 to 0.5 μm.

The write coil layer 343 is formed on an insulating layer 3421 made of insulating material such as Al₂O₃ (alumina), in such a way to pass through in one turn at least between the main magnetic pole layer 340 and the write shield layer 345, and has a spiral structure with a back contact portion 3402 as a center. The write coil layer 343 is formed of conductive material such as Cu (copper), and has a thickness of, for example, approximately 0.3 to 5 μm. The write coil layer 343 is covered with a write coil insulating layer 344 that is formed of insulating material such as a heat-cured photoresist and electrically isolates the write coil layer 343 from the main magnetic pole layer 340 and the write sheild layer 345. The write coil layer 343 has a monolayer structure in the present embodiment, however, may have a two or more layered structure or a helical coil shape. Further, the number of turns of the write coil layer 343 is not limited to that shown in FIG. 2, and may be, for example, in the range from two to seven.

The write shield layer 345 reaches the head end surface 300, and acts as a magnetic path for magnetic flux that returns from the soft-magnetic under layer provided below the perpendicular magnetization layer of the magnetic disk. The thickness of the write shield layer 345 is, for example, in the range of approximately 0.5 to 5 μm. Further, a portion of the write shield layer 345, opposed to the main magnetic pole 340 through the electromagnetic-field generating element 37, also reaches the head end surface 300. This portion is a trailing shield 3450 provided for receiving magnetic flux spreading from the main magnetic pole layer 340. In the present embodiment, the trailing shield 3450 is planarized together with an insulating layer 3420 and the main pole body 3401, and has a width in the track width direction (Y-axis direction) larger than the width of the main pole rear end 3400b and the main pole body 3401 as well as the main pole front end 3400a. The write shield layer 345 is formed of soft-magnetic material. Especially, the trailing shield 3450 is formed of, for example, material with high saturation magnetic flux density, such as NiFe (Permalloy) or an iron alloy as the main magnetic pole 3400 is formed of.

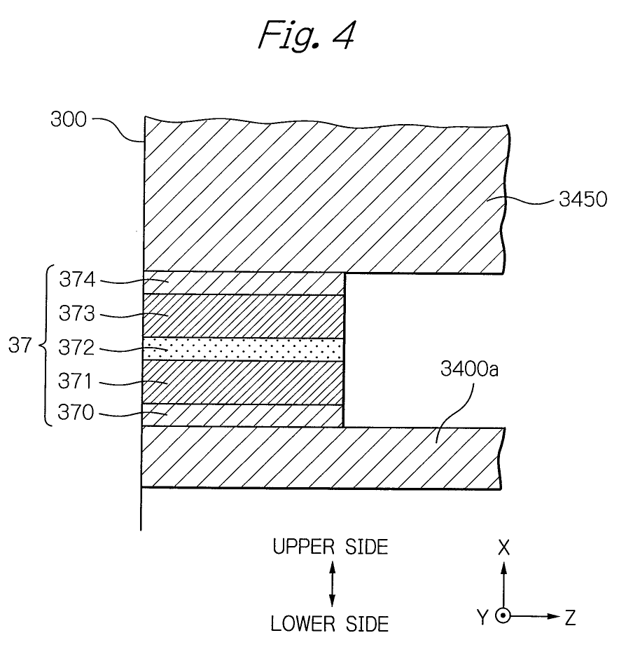

The electromagnetic-field generating element 37 is provided between the main pole front end 3400a and the trailing shield 3450, so as to reach the head end surface 300. The electromagnetic-field generating element 37 includes a spin-wave excitation layer 371 (FIG. 4) for generating high frequency electromagnetic field by the excitation of spin wave, which is provided adjacent to the main pole front end 3400a and has a magnetization with its direction changed according to external magnetic fields, as described with a figure in detail later. The magnetization of the spin-wave excitation layer 371 is biased in the direction substantially perpendicular to the layer surface by a portion of magnetic field generated from the main pole front end 3400a. In this biased state, electric current flowing in the element 37 in the direction from the trailing shield 3450 to the main pole front end 3400a causes spin wave to be excited in the spin-wave excitation layer 371. Then, the excited spin wave generates high frequency electromagnetic field with a frequency in microwave range. Here, “the direction substantially perpendicular to the layer surface” means as follows: The magnetic flux corresponding to magnetic field generated from the main pole front end 3400a provided for generating write field, has a contour of curved line, not a straight line in a precise sense, even in the electromagnetic-field generating element 37. And the degree of the curve depends on the design of the head. Therefore, even in the case that: the electromagnetic-field generating element 37 is provided between the main pole front end 3400a and the trailing shield 3450; and the magnetic flux curves slightly due to a certain head design; thus the corresponding magnetic field slightly deviates from the direction perpendicular to the layer surface, the magnetic field is regarded to be “substantially” perpendicular to the layer surface.

The generated high frequency electromagnetic field has an in-plane component in the direction within the perpendicular magnetization layer of the magnetic disk, at a position in the perpendicular magnetization layer. Thus, applying the high frequency electromagnetic field to a portion of the perpendicular magnetization layer enables anisotropic magnetic field H_{K} of the portion to be reduced. Here, the anisotropic magnetic field H_{K} is a physical quantity that gives coercive force H_{C}. Then, write field generated from the main pole front end 3400a is applied to the portion where anisotropic magnetic field H_{K} decreases. As a result, it becomes able to perform write operation to the perpendicular magnetization layer originally having a significantly strong anisotropic magnetic field H_{K;} thus realized is an adequate microwave-assisted magnetic recording.

The gap layer 341 is provided between the main magnetic pole 3400 and the trailing shield 3450, and surrounds the electromagnetic-field generating element 37 by its both sides in the track width direction (Y-axis direction) and its rear side (+Z direction side). The gap layer 341 is formed, for example, of non-magnetic insulating material such as Al₂O₃ (alumina), SiO₂ (silicon dioxide), AlN (aluminum nitride) or DLC, with a thickness of, for example, approximately 0.01 to 0.1 μm.

A portion of the write shield layer 345 is an electrically insulating layer 346. Therefore, a portion of the write shield layer 345, from the trailing shield 3450 to the end contacting with the electrically insulating layer 346 is electrically isolated with the main magnetic pole layer 340 and a portion of the write shield layer 345 below the electrically insulating layer 346. Further, both the portions isolated with each other are electrically connected with the respective drive electrodes 36. Thus, the main pole front end 3400a that is an end portion on the head end surface 300 side of the main magnetic pole layer 340 and the trailing shield 3450 act as electrodes for applying electric current that excites spin wave to the electromagnetic-field generating element 37.

The electrically insulating layer 346 is formed of electrically insulating material, preferably of magnetic material with electric insulation property such as ferromagnetic oxide, for example, ferrite. The layer thickness is, for example, in the range of approximately 50 nm to 2 μm. The electrically insulating layer 346 may be provided in the main magnetic pole layer 340, under the condition that the main pole front end 3400a and the trailing shield 3450 can act as the electrodes.

The backing coil layer 347 is a coil for negating a magnetic flux loop that is derived from write current applied to the write coil layer 343 of the electromagnetic transducer 34 and passes through the upper and lower shield layers 334 and 330 of the MR element 33. That is, the backing coil layer 347 is provided for suppressing unwanted writing or erasing operation by generating magnetic flux to negate the above-described magnetic flux loop. The backing coil layer 347 has a spiral structure with a back contact portion 3402 as a center, and is set so that the write current flows in the direction, for example, opposite to that in the write coil layer 343. And the layer 347 is electrically isolated by being surrounded with the backing coil insulating layer 348. The backing coil layer 347 has a monolayer structure in the present embodiment, however, may have a two or more layered structure or a helical coil shape. Further, the number of turns of the backing coil layer 347 is not limited to that shown in FIG. 2, and may be, for example, in the range from two to seven in accordance with the number of turns of the write coil layer 343.

Further, in the present embodiment, an inter-element shield layer 38 is provided between the MR element 33 and the electromagnetic transducer 34, sandwiched by the insulating layers 321 and 322. The inter-element shield layer 38 plays a role mainly for shielding the MR element 33 from magnetic field generated by the electromagnetic transducer 34, and may be formed of the same soft-magnetic material as the upper and lower shield layers 334 and 330, and the thickness of the layer 38 is, for example, in the range of approximately 0.5 to 5 μm. The above-described backing coil layer 347, the backing coil insulating layer 348, and the inter-element shield layer 38 are preferably provided; however, the microwave-assisted magnetic recording according to the present invention can be implemented without these layers.

FIG. 3a shows a top view, obtained when viewed down from the position directly above the element formation surface 31, schematically illustrating positions and shapes of the main magnetic pole layer 340, the electromagnetic-field generating element 37 and the write shield layer 345 of the electromagnetic transducer 34. FIG. 3b shows a side view, obtained when viewed from the ABS 30 side, schematically illustrating positions and shapes of the end surfaces of the main magnetic pole layer 340, the electromagnetic-field generating element 37 and the write shield layer 345, which appear on the head end surface 300.

As shown in FIG. 3a, the main magnetic pole 3400 is battledore-shaped, and the main pole front end 3400a, which reaches the head end surface 300, corresponds to the holding part of the battledore. The length (height) in the direction perpendicular to the head end surface 300 (Z-axis direction) of the main pole front end 3400a is defined as a throat height TH that is one of determination factors of the write characteristic of the head. In the present embodiment, the height in the direction perpendicular to the head end surface 300 (Z-axis direction) of the trailing shield 3450 is also set to be equal to the throat height TH; however the height may be different from the throat height TH.

As shown in FIG. 3b, the electromagnetic-field generating element 37 is sandwiched between the main pole front end 3400a and the trailing shield 3450. Here, the respective widths W_{P}, W_{S} and W_{T} in the track width direction (Y-axis direction) of the main pole front end 3400a, the electromagnetic-field generating element 37 and the trailing shield 3450 are set so as to satisfy the relation of W_{S}<W_{P}<W_{T}, in the present embodiment. These widths W_{P}, W_{S} and W_{T} can be set to be, for example, in the range of approximately 800 nm to 50 μm, approximately 10 nm to 500 nm and approximately 1 μm to 100 μm, respectively.

The propagation range in the track width direction (Y-axis direction) of the high frequency electromagnetic field generated from the electromagnetic-field generating element 37 is almost the same as the width W_{S}, in the position of the perpendicular magnetization layer of the magnetic disk, under the condition that the flying height of the head is about 10 nm or less. A portion of the perpendicular magnetization layer, which receives this high frequency electromagnetic field, becomes writable. Therefore, The width W_{S} of the electromagnetic-field generating element 37 indeed determines the width of the track formed on the perpendicular magnetization layer by write operation. Thereby, understandably, microwave-assisted magnetic recording in which the microwave is dominant can be realized. Here, the height H_{S} (FIG. 3a) in the height direction (Z-axis direction) of the electromagnetic-field generating element 37 is, for example, in the range of approximately 10 to 500 nm, and the thickness L_{S} (FIG. 3b) in X-axis direction is, for example, in the range of approximately 20 to 250 nm. The thickness L_{S} (FIG. 3b) is equivalent to a write gap value between the main pole front end 3400a and the trailing shield 3450.

Further, the main pole front end 3400a appearing on the head end surface 300 has a reverse trapezoidal shape with a longer edge on the trailing side (+X direction side). The length of the longer edge is identical to the above-described width W_{P} of the main pole front end 3400a. That is to say, the end surface on the head end surface 300 of the main pole front end 3400a has a bevel angle θ_{B}. The bevel angle θ_{B} is a angle for preventing unwanted writing and so on performed to the adjacent tracks due to the influence of a skew angle of the head, which arises from the angular-pivoting movement of the rotary actuator. The bevel angle θ_{B} is, for example, approximately 15°.

FIG. 4 shows a cross-sectional view taken by plane A in FIG. 1, schematically illustrating the structure of an embodiment of the electromagnetic-field generating element 37.

As shown in FIG. 4, the electromagnetic-field generating element 37 is pinched by the main pole front end 3400a and the trailing shield 3450, and one end of the element 37 forms a portion of the head end surface 300. The electromagnetic-field generating element 37 has a structure in which subsequently stacked, from the main pole front end 3400a side, are: a base layer 370; a spin-wave excitation layer 371 for generating high frequency electromagnetic field by the excitation of spin wave, having a magnetization with its direction changed according to external magnetic fields; a non-magnetic intermediate layer 372; a magnetization free layer 373 having a magnetization with its direction changed according to external magnetic fields; and a protecting layer 374.

The base layer 370 is formed of, for example, non-magnetic conductive material such as Ni₆₀Cr₄₀, Ta, Ru, Cr, Ti or W, with a thickness of, for example, approximately 0.5 to 10 nm. The spin-wave excitation layer 371 is formed of, for example, soft-magnetic conductive material such as Co₅₀Fe₅₀, with a thickness of, for example, approximately 5 to 100 nm. The non-magnetic intermediate layer 372 is formed of, for example, non-magnetic conductive material such as Cu, non-magnetic material such as ZnO or Al₂O₃, or a three-layered structure of non-magnetic-conductive-material/semiconducting-material/non-magnetic-conductive-material such as Cu/ZnO/Cu, with a thickness of, for example, approximately 1 to 5 nm. The magnetization free layer 373 is formed of, for example, soft-magnetic conductive material such as Co₉₀Fe₁₀, with a thickness of, for example, approximately 5 to 100 nm. The protecting layer 374 is formed of, for example, conductive material such as Ta, with a thickness of, for example, approximately 0.5 to 50 nm.

As described above, the electromagnetic-field generating element 37 includes the spin-wave excitation layer 371 and the magnetization free layer 373 formed of, for example, soft-magnetic material, each of which has a magnetization with its direction changed according to external magnetic fields. However, the element 37 does not require a ferromagnetic layer having a magnetization with fixed direction, such as a magnetization pinned layer or a biasing magnetic layer for applying bias field. Therefore, the process of forming the element becomes comparatively easy to be performed, which contributes to the reduction of man-hour for manufacturing. Further, as explained in detail later, the electromagnetic-field generating element 37 resolves the problem that the pinning (fixing) of the magnetization direction would be violated by significantly strong write field whose direction is frequently reversed.

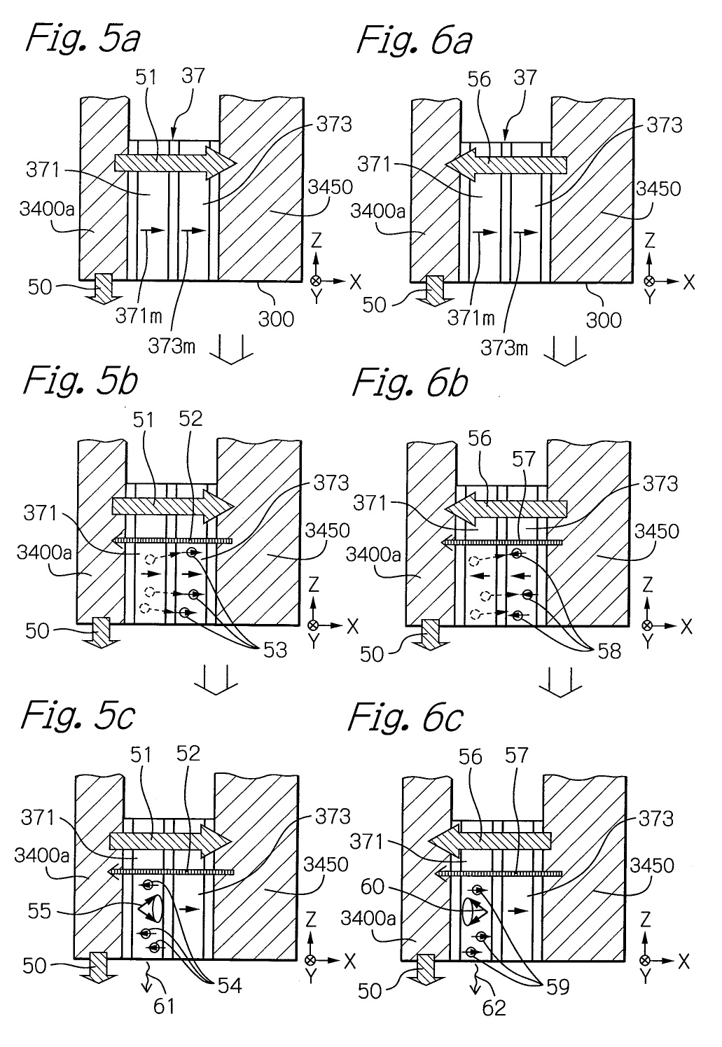

FIGS. 5a to 5c and FIGS. 6a to 6c show schematic views illustrating the configuration of the electromagnetic-field generating element 37 and its surrounding, for explaining the operating principle of the element 37.

First, FIGS. 5a to 5c indicate the case in which magnetic field 51 generated from the main pole front end 3400a has +X direction. As shown in FIG. 5a, in the operation of writing data, write field 50 is generated in the direction from the main pole front end 3400a toward the perpendicular magnetization layer of the magnetic disk (in −Z direction), while main pole magnetic field 51 is generated in the direction from the main pole front end 3400a toward the trailing shield 3450 (in +X direction). The write field 50 and the main pole magnetic field 51 have significantly great intensities of, for example, approximately 15 kOe and 10 kOe, respectively.

The electromagnetic-field generating element 37 receives the main pole magnetic field 51 having +X direction; thus, respective magnetizations 371m and 373m of the spin-wave excitation layer 371 and magnetization free layer 373 are directed (biased) in +X direction perpendicular to the layer surfaces. Here, both the layer surfaces of the spin-wave excitation layer 371 and magnetization free layer 373 are perpendicular to the head end surface 300.

Then, as shown in FIG. 5b, spin-wave excitation current 52 is applied to the electromagnetic-field generating element 37, in the direction (−X direction) from the trailing shield 3450 to the main pole front end 3400a. The application of the current 52 is equivalent to the movement (injection) of free electrons 53, which exist in the spin-wave excitation layer 371 and have spins with right (+X) direction, into the magnetization free layer 373 through the non-magnetic intermediate layer 372. The magnetization 373m of the magnetization free layer 373 is already biased in +X direction by the main pole magnetic field 51; thus is further strongly pinned in +X direction by the injection of the free electrons 53 having spins with right (+X) direction.

Whereas, the spin-wave excitation layer 371 comes to have less free electrons having spins with right (+X) direction. This less-electrons state is equivalent to a state in which free electrons 54 having spins with left (−X) direction are injected, as shown in FIG. 5c. As a result, the magnetization 371m of the spin-wave excitation layer 371 starts a precession movement 55, trying to approach to a state of reversing in left (−X) direction; thus spin wave is excited. As the relaxation process of the excited spin wave, high frequency electromagnetic field 61 having an oscillating frequency f_{M} in microwave range corresponding to the frequency of the precession movement is generated from the spin-wave excitation layer 371.

Next, FIGS. 6a to 6c indicate the case in which magnetic field 56 generated from the main pole front end 3400a has −X direction. As shown in FIG. 6a, in the operation of writing data, write field 55 is generated in +Z direction, while main pole magnetic field 56 is generated in the direction from the trailing shield 3450 toward the main pole front end 3400a (in −X direction). The write field 55 and the main pole magnetic field 56 have significantly great intensities of, for example, approximately 15 kOe and 10 kOe respectively, as in the case shown in FIGS. 5a to 5c.

The electromagnetic-field generating element 37 receives the main pole magnetic field 56 having −X direction; thus, respective magnetizations 371m and 373m of the spin-wave excitation layer 371 and magnetization free layer 373 are directed (biased) in −X direction perpendicular to the layer surfaces. That is, both the magnetizations 371m and 373m are biased in the direction opposite to that in the case shown in FIGS. 5a to 5c.

Then, as shown in FIG. 6b, spin-wave excitation current 57 is applied to the electromagnetic-field generating element 37, in the direction (−X direction) from the trailing shield 3450 to the main pole front end 3400a, as the current 52 shown in FIGS. 5a to 5c. The application of the current 57 is equivalent to the movement (injection) of free electrons 58, which exist in the spin-wave excitation layer 371 and have spins with left (−X) direction, into the magnetization free layer 373 through the non-magnetic intermediate layer 372. The magnetization 373m of the magnetization free layer 373 is already biased in −X direction by the main pole magnetic field 56; thus is further strongly pinned in −X direction by the injection of the free electrons 58 having spins with left (−X) direction.

Whereas, the spin-wave excitation layer 371 comes to have less free electrons having spins with left (−X) direction. This less-electrons state is equivalent to a state in which free electrons 59 having spins with right (+X) direction are injected, as shown in FIG. 6c. As a result, the magnetization 371m of the spin-wave excitation layer 371 starts a precession movement 60, trying to approach to a state of reversing in right (+X) direction; thus spin wave is excited. As the relaxation process of the excited spin wave, high frequency electromagnetic field 62 having an oscillating frequency f_{M} in microwave range corresponding to the frequency of the precession movement is generated from the spin-wave excitation layer 371.

As described above, the electromagnetic-field generating element 37 can stably generate high frequency electromagnetic field having an oscillating frequency f_{M} in microwave range by applying the spin-wave excitation current in −X direction, even under the existence of main pole magnetic field whose direction is frequently reversed during write operation. Especially, the electromagnetic-field generating element 37 does not require a ferromagnetic layer having a magnetization with fixed direction, such as a magnetization pinned layer or a biasing magnetic layer. If such a layer exists, the magnetization of the layer would deviate from its proper direction to be fixed, by the main pole magnetic fields 51 and 56 that are significantly strong, for example about 10 kOe, and whose direction are frequently reversed during write operation. However, providing the electromagnetic-field generating element 37 can resolve such a problem; further, the element 37 positively utilizes the main pole magnetic field as a bias field. As a result, stable high frequency electromagnetic field can be generated regardless of the direction of the main pole magnetic field.

The oscillating frequency f_{M} of the high frequency electromagnetic field is represented by the following expression:

f_{M}=γ*(2π)⁻¹*((H+H_{K})*(H+H_{K}+4πM_{S}))^{-0.5} (1)

In the expression, γ is gyromagnetic ratio of the spin-wave excitation layer 371, and is approximately 0.0171 Oe*ns for Co₅₀Fe₅₀. H is the intensity of the main pole magnetic fields 51 and 56 of the main pole front end 3400a, and may be adjusted in the range of, for example, 5 to 20 kOe. H_{K} is the intensity of the anisotropic magnetic field of the spin-wave excitation layer 371, and is represented by H_{K}=2K_{U1}/M_{S}, where K_{U1} and M_{S} are magnetic anisotropy energy and saturation magnetization of the spin-wave excitation layer 371, respectively. The magnetic anisotropy energy K_{U1} of the layer 371 is preferably 10⁻⁴ erg/cm³ or less so that the direction of magnetization 371m can easily be reversed following the main pole magnetic fields 51 and 56. Actually, a soft-magnetic material with the magnetic anisotropy energy K_{U1} on the order of 10⁻² to 10⁻³ erg/cm³ can be used for forming the spin-wave excitation layer 371. The saturation magnetization M_{S} is, in the case of Co₅₀Fe₅₀ for example, on the order of 10⁴ Oe as a value of 4πM_{S}. The oscillating frequency f_{M} further depends on the spin-wave excitation current and the spin polarizability of the spin-wave excitation layer 371. That is, increasing the amount of spin-wave excitation current as well as setting the spin polarizability to be higher brings an effect equivalent to that in the case of increasing the intensity of applied magnetic field, in which the oscillating frequency f_{M} can become sufficiently high. For that reason, it is preferable that a material with higher spin polarizability such as Co₅₀Fe₅₀ is used for forming the spin-wave excitation layer 371. Further, it is also preferable that the spin-wave excitation layer 371 is provided with an axis of easy magnetization perpendicular to its layer surface by selecting an appropriate base layer 370 (FIG. 4). Setting the axis of easy magnetization reduces the dispersion of the biased magnetization; thus more stable high frequency electromagnetic field can be generated. Further, the magnetization free layer 373 also preferably has an axis of easy magnetization perpendicular to its layer surface; and further has magnetic anisotropy energy of 1×10⁴ erg/cm³ or less. Thereby realized is more adequate biased state.

In the case of using the spin-wave excitation layer 371 formed of the material having the above-described properties, the oscillating frequency f_{M} of the high frequency electromagnetic field increases with the intensity of the main pole magnetic fields 51 and 56 as a bias field; thus the oscillating frequency f_{M} can be set to be, for example, in the wide range of approximately 20 to 60 GHz. Here, the magnetic resonance frequency of the magnetic recording layer of the magnetic disk, which has a higher anisotropic magnetic field for microwave-assisted magnetic recording, has a significantly large value of, for example, approximately 50 GHz. Nevertheless, a high frequency electromagnetic field having substantially the same frequency as the above-described resonance frequency can be generated by using the spin-wave excitation layer 371.

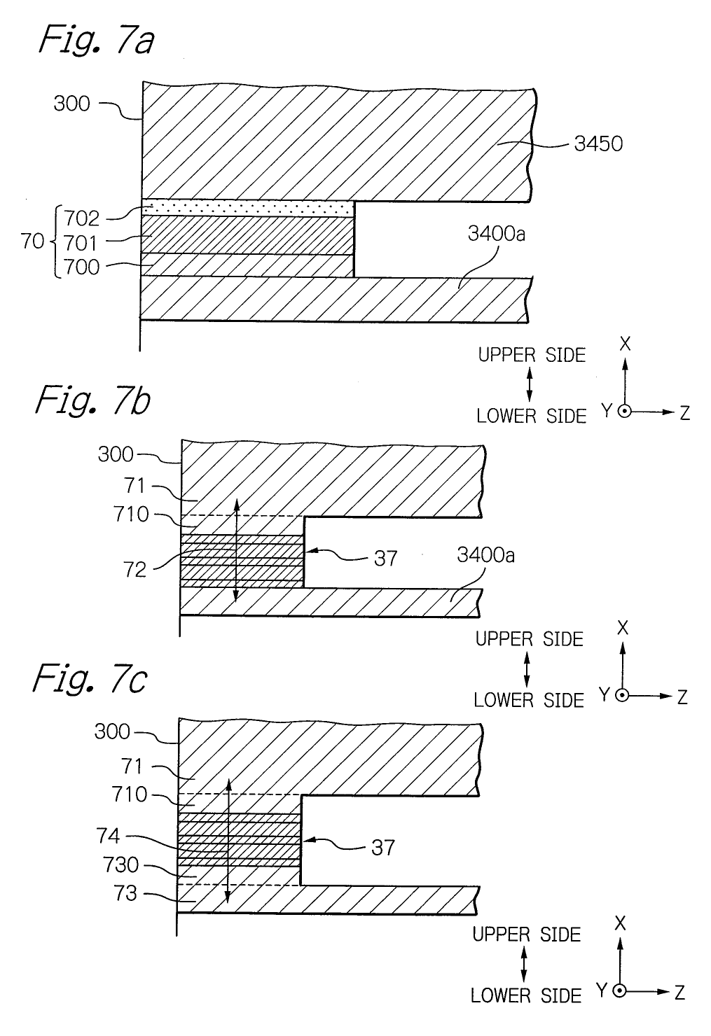

FIGS. 7a to 7c show cross-sectional views taken by a plane corresponding to plane A shown in FIG. 1, schematically illustrating the structures of other embodiments of the electromagnetic transducer including the electromagnetic-field generating element.

As shown in FIG. 7a, an electromagnetic-field generating element 70 is pinched by the main pole front end 3400a and the trailing shield 3450, and one end of the element 70 is positioned to form a portion of the head end surface 300. The electromagnetic-field generating element 70 has a structure in which subsequently stacked, from the main pole front end 3400a side, are: a base layer 700; a spin-wave excitation layer 701 for generating high frequency electromagnetic field by the excitation of spin wave, having a magnetization with its direction changed according to external magnetic fields; and a non-magnetic intermediate layer 702. That is, compared with the electromagnetic-field generating element 37 (FIG. 4), the electromagnetic-field generating element 70 does not have the magnetization free layer 373 and protecting layer 374 which are included in the element 37. The base layer 700 is formed of, for example, non-magnetic conductive material such as Ni₆₀Cr₄₀, Ta, Ru, Cr, Ti or W, with a thickness of, for example, approximately 0.5 to 10 nm. The spin-wave excitation layer 701 is formed of, for example, soft-magnetic conductive material such as Co₅₀Fe₅₀, with a thickness of, for example, approximately 5 to 100 nm. The non-magnetic intermediate layer 702 is formed of, for example, non-magnetic conductive material such as Cu, non-magnetic material such as ZnO or Al₂O₃, or a three-layered structure of non-magnetic-conductive-material/semiconducting-material/non-magnetic-conductive-material such as Cu/ZnO/Cu, with a thickness of, for example, approximately 1 to 5 nm.

In the case of using the electromagnetic-field generating element 70, a portion of the trailing shield 3450 acts as a magnetization free layer. Therefore, the same precession movement as the precession movement 55 shown in FIG. 5c or the precession movement 60 shown in FIG. 6c occurs in the spin-wave excitation layer 701 by applying the spin-wave excitation current in −X direction, even under the existence of main pole magnetic field whose direction is frequently reversed during write operation. As a result, spin wave is excited. As the relaxation process of the excited spin wave, high frequency electromagnetic field having an oscillating frequency f_{M} in microwave range corresponding to the frequency of the precession movement is generated from the spin-wave excitation layer 701.

As shown in FIG. 7b, the electromagnetic-field generating element 37 is pinched by the main pole front end 3400a and the trailing shield 71, and receives main pole magnetic field 72 as a bias field. The trailing shield 71 includes a protruding portion 710 which is provided on a portion of the shield 71 on the head end surface 300 side opposed to the main pole front end 3400a, and protrudes in the direction toward the main pole front end 3400a (in −X direction). As a result, the direction of main pole magnetic field 72 surely becomes perpendicular to each of layer surfaces of the electromagnetic-field generating element 37 due to the existence of the protruding portion 710. Thereby realized is more adequate biased state, and thus more stable high frequency electromagnetic field can be generated.

As shown in FIG. 7c, the electromagnetic-field generating element 37 is pinched by a main pole front end 73 and the trailing shield 71, and receives main pole magnetic field 74 as a bias field. As described above, the trailing shield 71 includes a protruding portion 710. Further, the main pole front end 73 also includes a protruding portion 730 which is provided on a portion of the main pole front end 73 on the head end surface 300 side opposed to the trailing shield 71, and protrudes in the direction toward the trailing shield 71 (in +X direction). As a result, the direction of main pole magnetic field 74 surely becomes perpendicular to each of layer surfaces of the electromagnetic-field generating element 37 due to the existence of the protruding portions 710 and 730. Thereby realized is more adequate biased state, and thus more stable high frequency electromagnetic field can be generated. In addition, the configuration that only the main pole front end includes a protruding portion out of the main pole front end and trailing shield which sandwich the electromagnetic-field generating element 37 therebetween, can also bring an adequate biased state; thus can be in the scope of the present invention. Further, alternatively, the electromagnetic-field generating element 37 shown in FIGS. 7b and 7c may be substituted with the electromagnetic-field generating element 70 shown in FIG. 7a. In this case, the protruding portion 710 of the trailing shield 71 acts as a magnetization free layer.

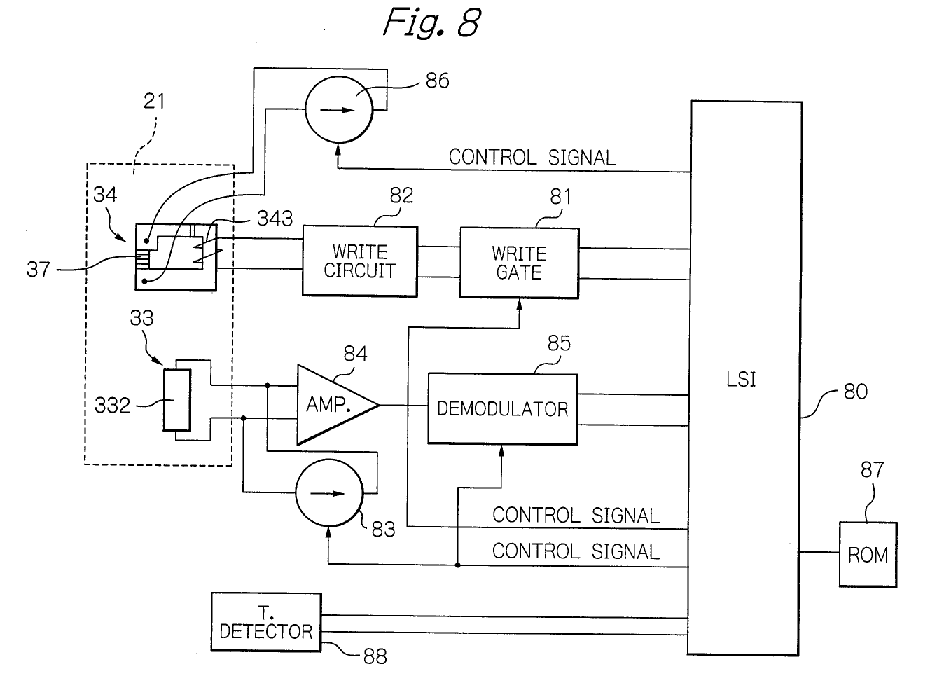

FIG. 8 shows a block diagram illustrating the circuit structure of the recording/reproducing and spin-wave control circuit 13 of the magnetic disk drive apparatus shown in FIG. 1.

In FIG. 8, reference numeral 80 indicates a control LSI, 81 indicates a write gate for receiving record data from the control LSI 80, 82 indicates a write circuit for applying write current to the electromagnetic transducer 34, 83 indicates a constant current circuit for supplying sense current to the MR effect element 33, 84 indicates an amplifier for amplifying the output voltage from the MR element 33, 85 indicates a demodulator circuit for outputting reproduced data to the control LSI 80, 86 indicates a constant current circuit for supplying spin-wave excitation current to the electromagnetic-field generating element 37, 87 indicates a ROM for stores a control table and so on for controlling the spin-wave excitation current, and 88 indicates a temperature detector, respectively.

The record data outputted from the control LSI 80 is supplied to the write gate 81. The write gate 81 supplies record data to the write circuit 82 only when recording control signal outputted from the control LSI 80 instructs write operation. The write circuit 82 passes write current corresponding to this record data through the write coil layer 343; thus the electromagnetic transducer 34 applies write field to the perpendicular magnetization layer of the magnetic disk. Whereas, constant current flows from the constant current circuit 83 to the MR multilayer 332 only when reproducing control signal outputted from the control LSI 80 instructs read operation. The signal reproduced by the MR element 33 is amplified by the amplifier 84, and demodulated by the demodulator circuit 85; thus the obtained reproduced data is outputted to the control LSI 80.

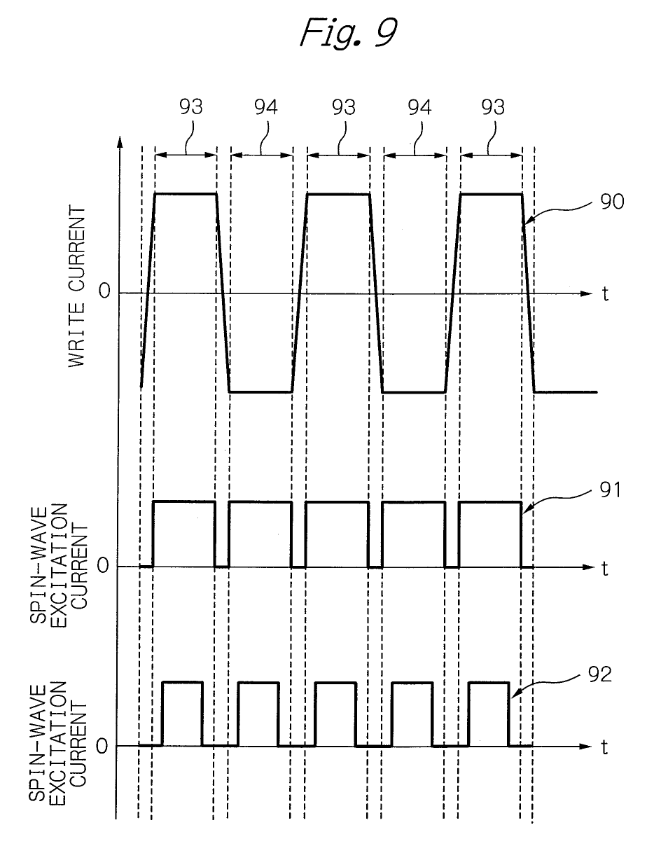

The constant current circuit 86 receives spin-wave control signal outputted from the control LSI 80. Only when the spin-wave control signal instructs spin-wave excitation operation, a predetermined spin-wave excitation current is applying to the electromagnetic-field generating element 37. The amount of the spin-wave excitation current is controlled to a value corresponding to the spin-wave control signal. The control LSI 80 determines the value of the spin-wave control signal based on the control table, under taking into account the measured temperature value obtained from the temperature detector 88 in a position of the perpendicular magnetization layer of the magnetic disk. The value of the spin-wave control signal is determined so that the frequency of high frequency electromagnetic field generated from the electromagnetic-field generating element 37 becomes substantially equal to the magnetic resonance frequency of the perpendicular magnetization layer. Further, the control LSI 80 supplies the spin-wave control signal according to the timing of write operation, as shown in FIG. 9 explained layer. Here, “substantially equal to the magnetic resonance frequency” means as follows: Even in the case that the frequency f_{M} of high frequency electromagnetic field, with which the perpendicular magnetization layer is irradiated, is shifted slightly from the magnetic resonance frequency f_{R} of the perpendicular magnetization layer, the anisotropic magnetic field of the perpendicular magnetization layer can be reduced accordingly. Therefore, the range of the frequency f_{M} in which the anisotropic magnetic field of the perpendicular magnetization layer is reduced to the degree of enabling write operation, can be regarded as a range of “being substantially equal to the magnetic resonance frequency”.

By using the above-described control circuit, it is possible to realize spin-wave excitation current cooperating with the write current in various modes. Further, it is obvious that the circuit structure of the recording/reproducing and spin-wave control circuit 13 is not limited to that shown in FIG. 8. It is also possible to directly control the constant current circuit 86 for supplying the spin-wave excitation current by using the recording control signal.

FIG. 9 shows a graph illustrating waveforms of spin-wave excitation current, for explaining an embodiment of the magnetic recording method according to the present invention. In the graph, the horizontal axis is time t, and the vertical axis is the amount of write current or spin-wave excitation current.

As shown in FIG. 9, a waveform 90 of write current is rectangular-wave-shaped, and shows a certain positive value of the write current in time periods 93 and a certain negative value of the write current in time periods 94. In time periods 93, write field 50 with a certain value and main pole magnetic field 51 (FIG. 5a) with a certain value are generated corresponding to the write current. While, in time periods 94, write field 55 with a certain value and main pole magnetic field 56 (FIG. 6a) with a certain value are generated corresponding to the write current.

Whereas, a waveform 91 of spin-wave excitation current is rectangular-pulse-shaped, and is formed so that the presence time of the pulse coincides with time periods 93 and 94. Therefore, the pulse width is almost equivalent to a time period 93 or 94. As a result, in the electromagnetic-field generating element, the spin-wave excitation current is supplied necessarily under the condition of stably applying the main pole magnetic fields 51 and 56 (FIGS. 5a and 6a) as a bias magnetic field. Here, the frequency of high frequency electromagnetic field generated from the electromagnetic-field generating element depends on the intensity of the bias magnetic field, and generally increases with the intensity. Therefore, by using the waveform 91 of the spin-wave excitation current which coordinates with the waveform 90 of write current, stable high frequency electromagnetic field having an intended frequency can be generated.

Alternatively, a waveform 92 may be used as spin-wave excitation current. The waveform 92 of spin-wave excitation current is rectangular-pulse-shaped as waveform 91 is; however, the waveform 92 is formed so that the presence time of each pulse corresponds to a portion of a time period 93 or 94. Therefore, the pulse width becomes shorter than a time period 93 or 94. Also in this case, the spin-wave excitation current is supplied necessarily under the condition of stably applying the main pole magnetic fields 51 and 56 (FIGS. 5a and 6a) as a bias magnetic field. Here, the time for actually performing write operation to the perpendicular magnetization layer becomes a time formed by adding the time within the pulse width to a time when the magnetic anisotropy of the perpendicular magnetization layer starts returning to its original state and exceeds the limit value of enabling write operation, in each case of waveforms 91 and 92. Anyway, stable high frequency electromagnetic field having an intended frequency can be generated, by applying the spin-wave excitation current to the electromagnetic-field generating element after the write field rises, and by stopping the spin-wave excitation current before the write field falls.

Hereinafter, explained will be practical examples 1 and 2 in which microwave was generated by using thin-film magnetic head according to the present invention.

### PRACTICAL EXAMPLE 1

Table 1 shows the configuration of the electromagnetic-field generating element 37 (FIG. 4) used for practical example 1.

TABLE 1

| Electromagnetic-field | | Constituent | |
|---|---|---|---|
| generating element 37 | | material | Thickness (nm) |
| Configuration | Protecting | Ta | 5 |
| | layer 374 | | |
| | Free layer 373 | Co₉₀Fe₁₀ | 30 |
| | Intermediate | Cu | 2.5 |
| | layer 372 | | |
| | Excitation | Co₅₀Fe₅₀ | 20 |
| | layer 371 | | |
| | Base layer 370 | Ni₆₀Cr₄₀ | 2 |

| | |
|---|---|
| Layer surface area (nm × nm) | about 40 × about 40 |
| Element resistance (Ω) | 25 |
| MR ratio (ratio of | 5 |
| resistance change) (%) | |

In table 1, the layer surface of the layer surface area forms YZ-plane. Each layer of the electromagnetic-field generating element 37 was formed by using sputtering method; sequentially stacked, from the formed main pole front end 3400a, were a base layer 370, a spin-wave excitation layer 371, a non-magnetic intermediate layer 372, a magnetization free layer 373 and a protecting layer 374. An induced magnetic anisotropy with the direction perpendicular to the layer surface was given, by applying magnetic field of 50 Oe perpendicular to the layer surface during depositing the spin-wave excitation layer 371 and the magnetization free layer 373. Thus after manufacturing thin-film magnetic heads 21 including the formed electromagnetic-field generating element 37 and the MR element 33 and electromagnetic transducer 34 (FIG. 2 and FIGS. 3a and 3b), the electromagnetic transducer 34 was brought into operation, and write current was adjusted so that magnetic field of 10 kOe was applied to the electromagnetic-field generating element 37 in the direction perpendicular to each layer surface of the element 37. In that state, direct current was applied between drive electrodes 36 which are connected with the main pole magnetic layer 340 and the write shield layer 345, respectively; thus, spin-wave excitation current with current density of 8×10⁷ A/m² was applied to electromagnetic-field generating element 37 in the direction from the write shield layer 345 to the main pole front end 3400a.

In this case, in advance, an electromagnetic wave sensor was set adjacent to the electromagnetic-field generating element 37 exposed on the head end surface 300 (TBS 30) of the formed thin-film magnetic head 21. By analyzing the output of the sensor with use of a spectrum analyzer, recognized was an oscillation of microwave of approximately 50 kHz.

### PRACTICAL EXAMPLE 2

Table 2 shows the configuration of the electromagnetic-field generating element 70 (FIG. 7a) used for practical example 2.

TABLE 2

| Electromagnetic-field | | Constituent | |
|---|---|---|---|
| generating element 70 | | material | Thickness (nm) |
| Configuration | Intermediate | Cu | 2.5 |
| | layer 702 | | |
| | Excitation | Co₅₀Fe₅₀ | 20 |
| | layer 701 | | |
| | Base layer 700 | Ni₆₀Cr₄₀ | 2 |

| | |
|---|---|
| Layer surface area (nm × nm) | about 40 × about 40 |
| Element resistance (Ω) | 23 |
| MR ratio (ratio of | 5 |
| resistance change) (%) | |

In table 2, the layer surface of the layer surface area forms YZ-plane. Each layer of the electromagnetic-field generating element 70 was formed by using sputtering method; sequentially stacked, from the formed main pole front end 3400a, were a base layer 700, a spin-wave excitation layer 701, and a non-magnetic intermediate layer 702. An induced magnetic anisotropy with the direction perpendicular to the layer surface was given, by applying magnetic field of 50 Oe perpendicular to the layer surface during depositing the spin-wave excitation layer 701. Thus after manufacturing thin-film magnetic heads 21 including the formed electromagnetic-field generating element 70 and the MR element 33 and electromagnetic transducer 34 (FIG. 2 and FIGS. 3a and 3b), the electromagnetic transducer 34 was brought into operation, and write current was adjusted so that magnetic field of 10 kOe was applied to the electromagnetic-field generating element 70 in the direction perpendicular to each layer surface of the element 70. In that state, direct current was applied between drive electrodes 36 which are connected with the main pole magnetic layer 340 and the write shield layer 345, respectively; thus, spin-wave excitation current with current density of 8×10⁷ A/m² was applied to electromagnetic-field generating element 70 in the direction from the write shield layer 345 to the main pole front end 3400a.

In this case, in advance, an electromagnetic wave sensor was set adjacent to the electromagnetic-field generating element 70 exposed on the head end surface 300 (TBS 30) of the formed thin-film magnetic head 21. By analyzing the output of the sensor with use of a spectrum analyzer, recognized was an oscillation of microwave of approximately 50 kHz, as in the case of practical example 1.

As described above, according to the present invention, stable high-frequency electromagnetic field with a desired frequency can be generated, even under the existence of significantly strong write field, generated from the main magnetic pole layer, whose direction is frequently reversed. Thereby, an excellent microwave-assisted magnetic recording can be realized, which can contribute to the achievement of record density exceeding, for example, 1 Tbit/in².

All the foregoing embodiments are by way of example of the present invention only and not intended to be limiting, and many widely different alternations and modifications of the present invention may be constructed without departing from the spirit and scope of the present invention. Accordingly, the present invention is limited only as defined in the following claims and equivalents thereto.

1. A thin-film magnetic head comprising:
a first magnetic pole for generating a write field for writing to a magnetic recording medium, and a second magnetic pole; and
an electromagnetic-field generating element provided in a position reaching an opposed-to-medium surface, between said first magnetic pole and said second magnetic pole,
said electromagnetic-field generating element comprising; a spin-wave excitation layer provided adjacent to said first magnetic pole and having a magnetization with its direction varied according to external magnetic fields, for generating an high frequency electromagnetic field by an excitation of spin wave; and a non-magnetic intermediate layer provided on a side opposite to said first magnetic pole in relation to said spin-wave excitation layer, and
a magnetization of said spin-wave excitation layer being biased in a direction substantially perpendicular to its layer surface by a portion of magnetic field generated from said first magnetic pole, and an electric current for exciting the spin wave flowing in said electromagnetic-field generating element in a direction from said second magnetic pole to said first magnetic pole.

2. The thin-film magnetic head as claimed in claim 1, wherein said spin-wave excitation layer has a magnetic anisotropy energy of 1×10⁴ erg/cm³ or less.

3. The thin-film magnetic head as claimed in claim 1, wherein said spin-wave excitation layer has an axis of easy magnetization perpendicular to its layer surface.

4. The thin-film magnetic head as claimed in claim 1, wherein: said spin-wave excitation layer further comprises a magnetization free layer having a magnetization with its direction varied according to external magnetic fields; said non-magnetic intermediate layer is provided in a position sandwiched between said magnetization free layer and said spin-wave excitation layer; and a magnetization of said magnetization free layer is biased in a direction substantially perpendicular to its layer surface by a portion of magnetic field generated from said first magnetic pole.

5. The thin-film magnetic head as claimed in claim 4, wherein said magnetization free layer has a magnetic anisotropy energy of 1×10⁴ erg/cm³ or less.

6. The thin-film magnetic head as claimed in claim 4, wherein said magnetization free layer has an axis of easy magnetization perpendicular to its layer surface.

7. The thin-film magnetic head as claimed in claim 1, wherein said second magnetic pole comprises a protruding portion that is provided on an end portion on the opposed-to-medium surface side of said second magnetic pole, opposed to said first magnetic pole, and protrudes toward said first magnetic pole, and said electromagnetic-field generating element is provided between said protruding portion and said first magnetic pole.

8. The thin-film magnetic head as claimed in claim 1, wherein said first magnetic pole comprises a protruding portion that is provided on an end portion on the opposed-to-medium surface side of said first magnetic pole, opposed to said second magnetic pole, and protrudes toward said second magnetic pole, and said electromagnetic-field generating element is provided between said protruding portion and said second magnetic pole.

9. The thin-film magnetic head as claimed in claim 1, wherein a portion of said first magnetic pole or said second magnetic pole is formed of an electrically insulating layer, and an end portion on the opposed-to-medium surface side of said first magnetic pole and an end portion on the opposed-to-medium surface side of said second magnetic pole act as electrodes for applying the electric current for exciting the spin wave to said electromagnetic-field generating element.

10. The thin-film magnetic head as claimed in claim 1, wherein a width in a track width direction of an end on the opposed-to-medium surface side of said electromagnetic-field generating element is smaller than a width in a track width direction of an end on the opposed-to-medium surface side of said first magnetic pole.

11. The thin-film magnetic head as claimed in claim 1, wherein a frequency of the high frequency electromagnetic field generated from said spin-wave excitation layer is substantially equal to a magnetic resonance frequency of a magnetic recording layer of the magnetic recording medium to be written.

12. A head gimbal assembly comprising: the thin-film magnetic head as claimed in claim 1; and a support structure for supporting said thin-film magnetic head.

13. A magnetic recording apparatus comprising: at least one head gimbal assembly comprising a thin-film magnetic head and a suspension for supporting said thin-film magnetic head; at least one magnetic recording medium; and a recording circuit for controlling write operation of said thin-film magnetic head performed to said at least one magnetic recording medium,
said thin-film magnetic head comprising:
a first magnetic pole for generating a write field for writing to the magnetic recording medium, and a second magnetic pole; and
an electromagnetic-field generating element provided in a position reaching an opposed-to-medium surface, between said first magnetic pole and said second magnetic pole,
said electromagnetic-field generating element comprising; a spin-wave excitation layer provided adjacent to said first magnetic pole and having a magnetization with its direction varied according to external magnetic fields, for generating an high frequency electromagnetic field by an excitation of spin wave; and a non-magnetic intermediate layer provided on a side opposite to said first magnetic pole in relation to said spin-wave excitation layer,
a magnetization of said spin-wave excitation layer being biased in a direction substantially perpendicular to its layer surface by a portion of magnetic field generated from said first magnetic pole, and an electric current for exciting the spin wave flowing in said electromagnetic-field generating element in a direction from said second magnetic pole to said first magnetic pole, and
said recording circuit further comprising a spin-wave control circuit for controlling the electric current for exciting the spin wave.

14. The magnetic recording apparatus as claimed in claim 13, wherein said spin-wave excitation layer has a magnetic anisotropy energy of 1×10⁴ erg/cm³ or less.

15. The magnetic recording apparatus as claimed in claim 13, wherein said spin-wave excitation layer has an axis of easy magnetization perpendicular to its layer surface.

16. The magnetic recording apparatus as claimed in claim 13, wherein: said spin-wave excitation layer further comprises a magnetization free layer having a magnetization with its direction varied according to external magnetic fields; said non-magnetic intermediate layer is provided in a position sandwiched between said magnetization free layer and said spin-wave excitation layer; and a magnetization of said magnetization free layer is biased in a direction substantially perpendicular to its layer surface by a portion of magnetic field generated from said first magnetic pole.

17. The magnetic recording apparatus as claimed in claim 16, wherein said magnetization free layer has a magnetic anisotropy energy of 1×10⁴ erg/cm³ or less.

18. The magnetic recording apparatus as claimed in claim 16, wherein said magnetization free layer has an axis of easy magnetization perpendicular to its layer surface.

19. The magnetic recording apparatus as claimed in claim 13, wherein said second magnetic pole comprises a protruding portion that is provided on an end portion on the opposed-to-medium surface side of said second magnetic pole, opposed to said first magnetic pole, and protrudes toward said first magnetic pole, and said electromagnetic-field generating element is provided between said protruding portion and said first magnetic pole.

20. The magnetic recording apparatus as claimed in claim 13, wherein said first magnetic pole comprises a protruding portion that is provided on an end portion on the opposed-to-medium surface side of said first magnetic pole, opposed to said second magnetic pole, and protrudes toward said second magnetic pole, and said electromagnetic-field generating element is provided between said protruding portion and said second magnetic pole.

21. The magnetic recording apparatus as claimed in claim 13, wherein a portion of said first magnetic pole or said second magnetic pole is formed of an electrically insulating layer, and an end portion on the opposed-to-medium surface side of said first magnetic pole and an end portion on the opposed-to-medium surface side of said second magnetic pole act as electrodes for applying the electric current for exciting the spin wave to said electromagnetic-field generating element.

22. The magnetic recording apparatus as claimed in claim 13, wherein a width in a track width direction of an end on the opposed-to-medium surface side of said electromagnetic-field generating element is smaller than a width in a track width direction of an end on the opposed-to-medium surface side of said first magnetic pole.

23. The magnetic recording apparatus as claimed in claim 13, wherein a frequency of the high frequency electromagnetic field generated from said spin-wave excitation layer is substantially equal to a magnetic resonance frequency of a magnetic recording layer of the magnetic recording medium to be written.

24. A magnetic recording method comprising steps of:
biasing a magnetization of a spin-wave excitation layer including a layer surface perpendicular to an opposed-to-medium surface and having the magnetization with its direction varied according to external magnetic fields, in a direction substantially perpendicular to the layer surface, by a portion of magnetic field generated from a magnetic pole;
exciting a spin wave in said spin-wave excitation layer by applying an electric current to said spin-wave excitation layer with its magnetization biased;
reducing an anisotropic magnetic field of a portion of a magnetic recording medium, by applying a high frequency magnetic field generated by the spin wave to the portion of the magnetic recording medium, the high frequency magnetic field including an in-plane component in a direction within the magnetic recording medium; and
performing writing on the portion with the reduced anisotropic magnetic field of the magnetic recording medium, by applying a write field generated from said magnetic pole.

25. The magnetic recording method as claimed in claim 24, wherein a magnetic anisotropy energy of said spin-wave excitation layer is set to be 1×10⁴ erg/cm³ or less.

26. The magnetic recording method as claimed in claim 24, wherein an axis of easy magnetization of said spin-wave excitation layer is set to be perpendicular to its layer surface.

27. The magnetic recording method as claimed in claim 24, wherein, in a multilayer of said spin-wave excitation layer, a non-magnetic intermediate layer and a magnetization free layer having a magnetization with its direction varied according to external magnetic fields, magnetizations of said spin-wave excitation layer and said magnetization free layer are biased in a direction substantially perpendicular to their layer surfaces by a portion of magnetic field generated from said magnetic pole, and an electric current is applied to said multilayer from the magnetization free layer side to the spin-wave excitation layer side.

28. The magnetic recording method as claimed in claim 24, wherein a frequency of the high frequency electromagnetic field generated from said spin-wave excitation layer is set to be substantially equal to a magnetic resonance frequency of a magnetic recording layer of the magnetic recording medium to be written.

29. The magnetic recording method as claimed in claim 24, wherein the electric current is applied to said spin-wave excitation layer after the write field rises from said magnetic pole, and the electric current is stopped before the write field falls.
